(19) United States
(12) Patent Application Publication
(10) Pub. No.: US 2003/0027879 A1
(43) Pub. Date: Feb. 6, 2003

(54) Hypercrosslinked polymeric material for purification of physiological liquids of organism, and a method of producing the material

(76) Inventors: Vadim Davankov, Moscow (RU); Maria Tsyurupa, Moscow (RU); Ludmiia Pavlova, Moscow (RU)

Correspondence Address: ILYA ZBOROVSKY, 6 SCHOOLHOUSE WAY, DIX HILLS, NY, 11746, US

(21) Appl. No.: 09/848,601

(22) Filed: Jan. 11, 2001

Related U.S. Application Data
(63) Continuation-in-part of application No. 09/459,611, filed on Dec. 13, 1999, now abandoned.
Application No. 09/459,611 is a continuation-in-part of application No. 09/143,407, filed on Aug. 28, 1998, now abandoned.

(51) Int. Cl. C08J 9/00

(52) U.S. Cl. 521/82

(57) ABSTRACT

Hypercrosslinked polymeric adsorbents exhibiting improved porosity, namely, a combination of micropores, mesopores and macropores, with an enhanced portion of mesopores, are produced by radical suspension polymerization of divinylbenzene or copolymerization of styrene with more than 40 mol % of the aromatic divinyl compound in the monomer mixture, in the presence of diluents or mixtures thereof, which properties are close to those of θ-solvents, so that the divinyl compounds form bridges in sufficient numbers to produce a stable porous polymer network without additional subsequent bridging.

### CROSS REFERENCE TO A RELATED APPLICATION

This application is a continuation-in-part of application Ser. No. 09/459,611 which in turn is a continuation-in-part of application 09/143,407.

### BACKGROUND OF THE INVENTION

This invention relates to polymeric adsorbents of the hypercrosslinked type, methods of preparing the adsorbents, and uses of the adsorbents, preferably for sorption of large biologically active compounds, hemoperfusion, etc.

Porous polymeric materials, in particular, macroporous polystyrene resins, are widely used in manifold adsorption technologies. Best known example of this type of adsorbents is Amberlite XAD-4 manufactured by Rohm and Haas Company (U.S.). These materials are produced by suspension polymerization of divinylbenzene or copolymerization of the latter with styrene in the presence of a diluent which is miscible with the monomers, but causes precipitation of the polymer formed during the polymerization. Due to the micro phase separation in the polymeric bead under formation, the space occupied by the diluent gives rise to macro pores of the final material, whereas the precipitated polymeric phase represents rigid walls of the pores. Typical values of surface area of the macroporous adsorbents are less than 300-500 sq.m/g, typical pore diameters amount to several hundreds to several thousands angstrom. Macroporous polymers do not increase their volume in any liquid media.

A fundamentally different materials are hypercrosslinked polystyrene initially introduced in U.S. Pat. No. 3,729,457 and later described in details by V. A. Davankov and M. P. Tsyurupa in Reactive Polymers, 13, 27-42 (1990). These materials are prepared by an extensive crosslinking of long polystyrene chains in the presence of large amounts of a diluent which does not cause precipitation of the polymer formed. No phase separation takes place during the formation of the network of the polymer. At high crosslinking degrees, a rigid network is formed with an exceedingly high apparent surface area, about 1000 sq.m/g, and fine pores of 1.0-3.0 nm in diameter. A remarkable feature of these materials is that they swell in any liquid media, independent of their thermodynamic affinity to the polymeric network. Hypercrosslinked polystyrene displays unprecedented sorption capacity toward any organic compounds and vapors.

To enhance kinetics of sorption on hypercrosslinked resins and facilitate the technical use of these materials, the polymeric beads are provided with additional large macropores. One of possible protocols of producing such biporous materials is the intensive post-crosslinking of lightly crosslinked macroporous aromatic copolymer beads while in a swollen state, as described in U.S. Pat. No. 4,263,407. Best materials, that combine advantages of both macroporous and microporous hypercrosslinked network structures, are polymeric adsorbents of Macronet Hypersol MN series manufactured by Purolite Int. (U.K).

In some particular cases, however, neither macroporous nor microporous (hypercrosslinked) materials, display high adsorption capacity and acceptable rate of sorption. This is the case when relatively large molecular species are intended to be removed by adsorption from a solution. A typical example of such problems are removing toxic proteins and fragments of endotoxins from physiological liquids or size exclusion chromatography of oligomers. A desirable diameter of pores for the polymeric adsorbent for the above type of application would fit predominantly into the range of mesopores of about 1.0 to 10.0 nm.

Though there is no strict definition of micro-, meso-, and macro pores, majority of authors agree to refer to pores of less than 2.0 nm as micropores and those larger than 20.0 nm in diameter as macropores. By accepting these borders, one has to refer the intermediate range of pores of 2.0 to 20.0 nm in size as mesopores.

These considerations can be considered as corresponding to the generally accepted approach to the determination of the sizes of the pores in corresponding polymers.

U.S. Pat. No. 5,460,725 to Stringfield discloses a polymeric adsorbent with enhanced adsorption capacity in the mesoporous range a chemical method for preparing the material, and consequently a chemical composition of the material. In the patent to Stringfield polymerization is performed to form a porous material, and thereafter it is subjected to alkylene bridging. The second part of the method is not an option, but instead a necessary condition. It is stated in the patent that the methylene bridging serves to lock the polymer structure in place while swollen and prevent poor collapse. The material obtained in accordance with this patent displays the claimed porous structure in the swollen state only. On removing the swelling agent, the porous structure collapses. In order to obtain a material that preserves the desired porous structure in dry state or in an aqueous medium, in the patent it is absolutely necessary to enhance the rigidity of the network by additional alkylene bridging. The reason is that Stringfield uses from 20 to 35% of divinylbenzene only in the first polymerization step, which does not provide the polymer network with the required rigidity.

### SUMMARY OF THE INVENTION

An object of the invention is to provide synthetic polymeric adsorbents with an enhanced fraction of mesopores and develop a procedure of manufacturing the same.

In keeping with these objects and with others which will become apparent hereinafter, one feature of present invention resides, briefly stated in a porous polymeric adsorbing material with adsorption capacity with respect to solutes in a molecular weight range of 5,000 to 50,000 Dalton, with an enhanced portion of mesopores, in addition to micropores and macropores, and which is prepared by a method consisting of the step of polymerization of an aromatic divinyl compound or copolymerization of an aromatic monovinyl compound with more than 40 mol % of an aromatic divinyl compound, so that the aromatic divinyl compound with the quantity of more than 40 mol % forms cross-linking bridges itself in such numbers which make a porous polymer network stable without additional subsequent bridging, in the presence of porogens or mixtures of porogens with properties close to those of θ-solvents.

Another feature of present invention is embodied in a method of producing a porous polymeric adsorbing material with adsorption capacity with respect to solutes in a molecular weight range of 5,000 to 50,000 Dalton, consisting of the step of performing polymerization of an aromatic divinyl compound or copolymerization of an aromatic monovinyl compound with more than 40 mol % of the aromatic divinyl compound; and executing said polymerization or copolymerization, to produce a porous polymeric adsorbing material with an enhanced portion of mesopores, in addition to micropores and macropores, so that the aromatic divinyl compound with the quantity of more than 40 mol % forms cross-linking bridges itself in such numbers which make a porous polymer network stable without additional subsequent bridging,

When the material is formed and the method is performed in accordance with the present invention, synthetic polymeric adsorbents are provided with an enhanced fraction of mesopores, and an efficient method of producing the same is provided as well.

### DESCRIPTION OF PREFERRED EMBODIMENTS

The adsorbents of the invention are polymeric materials in spherical bead form with an enhanced fraction of mesopores and are produced by suspension polymerization of aromatic divinyl compounds or their copolymerization with aromatic monovinyl compounds in the presence of diluents which properties are similar to those of θ-solvents. Typically, divinylbenzene or its mixtures with ethylvinylbenzene and styrene are polymerized with appropriate amounts of a mixture of a good and a bad solvent for polystyrene.

Porous structure of polymeric materials is entirey determined by their rigidity and conditions of formation of their tridiimensional network.

When polymerization of a styrene-divinylbenzene mixture is carried out in the presence of a precipitating porogen, e.g., isoamyl alcohol, where phase separation takes place on early stages of the polymerization process, a macroporous material is formed. It has a relatively small surface area, large macropores and it does not swell (does not increase in volume) with hydrocarbons or alcohols which are bad solvating media for polystyrene. Preparation of such macroporous styrene-divinylbenzene copolymers is well documented in scientific and patent literature. It has been established that the crosslinking degree of these materials should exceed a certain minimum level in the range of 3% (Tschang et al., U.S. Pat. No. 4,266,030 1981) to 5% (Walters et al U.S. Pat. No. 3,275,548, 1966), but does not need to be too high (less than 30% divinylbenzene as in Werotte et al., U.S. Pat. No. 3,418,262, 1968). The circumstance correlates with the relatively large size of the pores and, correspondingly, with the relatively small surface area and small surface energy. Even the above moderate amount of crosslinks (divinylbenzene units) in the polymeric network is sufficient to withstand the natural trend of a porous material to collapse into a densely packed non-porous material.

When polymerizing divinylbenzene (or styrene-divinylbenzene) in the presence of a good solvent, e.g., toluene or diethylbenzene, where at moderate dilution degrees no phase separation takes place, a microporous network structure is formed. However, on removing the good solvent after the polymerization procedure, the microporous structure can be preserved only under the condition that the network formed is really rigid. This requires a very high proportion of divinylbenzene to be involved into polymerization, preferably more than 40%. Such densely crosslinked rigid networks must possess all peculiar properties of a typical hypercrosslinked network, that is, display an apparent surface area of over 1000 sq.m/g and the ability to swell, increase in volume, in any organic media. This type of rigid microporous polymer material (prepared by polymerization of styrene with more than 20% DBV in diethylbenzene, a good solvating media) proved to be useful column packing material in gas chromatography (Hollis, et al, U.S. Pat. No. 3,357,158, 1967).

In the present invention, the use of porogens is suggested which resemble θ-solvents for polystyrene. This allows one to postpone the phase separation to the very late stages of the polymerization process. At the initial stages, where the θ-solvent is mixed with relatively large amounts of unreacted monomers, the media maintains high affinity to the emerging network and no phase separation takes place. At these stages, a typically microporous network is formed. At the very last stages of the polymerization, where the amount of unreacted monomers is substantially reduced, the porogen gradually attains properties of a θ-solvent, thus stimulating phase separation. However, the continuous polymeric network already formed, does not break easily into large fragments. Predominantly meso-porous polymeric material is formed under these conditions. However, it also incorporates substantial proportion of micropores, and, therefore, is characterized by high inner surface area and high surface energy. For this reason, the tendency for a total collapse of the porous structure on removing the porogen is strong. The dry material remains porous only under condition that the network is rigid. It takes place when it incorporates large amounts, i.e., more than 40% of polymerized DVB. Since more than 40% of divinylbenzene is utilized, the divinyl compound forms cross-linking bridges itself in such numbers, which make the porous polymer network stable without any need to perform additional subsequent bridging for cross-linking purposes.

In the present invention, for the first time, two essential conditions for the preparation of stable polymeric materials with an enhanced proportion of mesopores are formulated and realized, namely

high rigidity of the polymeric network, attained, by using more than 40% DVB in copolymerization with styrene;

formation of the network in the presence of a porogen which properties are close to those of a θ-solvent

Besides typical θ-solvents for polystyrene, like cyclohexane (at 34° C.) and cyclohexanone (at 70° C.), mixtures of a good solvent with a precipitating solvent can simulate θ-conditions, As thermodynamically good solvents, toluene, xylene, diethylbenzene, benzene, ethylene dichloride, propylene dichloride, tetrachloroethylene, dioxane can be used, whereas precipitating components can be represented by hydrocarbons, aliphatic alcohols or acids. By changing the nature of the above two components, their proportions and total amounts, as well as the temperature conditions of the polymerization, it is possible to fine tune the porous structure of the final material, that is the proportions of micro, meso and macro pores. The later the phase separation takes place, the closer the properties of the polymeric adsorbent would resemble those of microporous hypercrosslinked materials. Contrary, an early phase separation would imply obtaining materials of a predominantly macroporous structure.

Using mixtures of toluene and heptane as porogens in copolymerization of styrene with divinylbenzene was mentioned by Kolarz et al. in Angewandte Makromoteculare Chemie, 161, 23-31 (1988). However, the crosslinking degree of the material synthesized was in the range of 5-20%, whereas formation of a stable hypercrosslinked network requires the crosslinking degree to be at least 40%. Therefore, the materials described in the above publication were of a typical macroporous structure, only. The same is valid for EP 0766701, where the copolymer was prepared in the presence of a mixture of toluene with an alkane (hexane to octane), but the range of the aromatic polyvinyl crosslinking agent amounted to 20-35% based on the total weight of monomers.

Similarly, the above formulated condition of high rigidity of the network was not met in U.S. Pat. No. 5,460,725, 1995, by Stringfield. The author polymerized styrene with 20 to 35% DVB in the presence of a porogen mixture (tolueneloctane) that can approach properties of a θ-solvent, and he arrived at a material with a substantial portion of meso pores. However, in the dry material, this useful porous structure could be preserved only after an additional haloalkylating of the copolymer beads and extensive post-crosslinking of the network of the beads by methylene bridging.

Highly crosslinked rigid materials obtained with θ-solvents or θ-mixtures as porogens in accordance with the present invention display the following set of important features, which distinguishes them from both typical macroporous and typical microporous hypercrosslinked materials:

high proportion of mesopores in the range of 2.0 to 20 nm, in addition to micropores and macropores;

high apparent surface area—up to 1200 sq.m/g;

increase in volume on treating dry material with typical non-solvents for polystyrene, e. g., with methanol or ethanol;

high mechanical strength;

high adsorption capacity with respect of solutes in the molecular weight range of 5,000 to 50,000 Da;

enhanced hemocompatibility, even without any additional chemical modification of the surface.

Most important area of application of the polymeric adsorbents of the invention could be hemoperfusion, since several toxic compounds with molecular weights of between 1500 and 15000 Daltons build up in abnormal quantities in uraemic and many other patients, but these species are only incompletely removed by conventional hemodialysis procedures.

The following examples are intended to illustrate, but not to limit the invention.

### EXAMPLE 1

Into a seven-liter four-necked round-bottom flask equipped with a stirrer, a thermometer and a reflux condenser, is placed the solution of 8.4 g polyvinyl alcohol-type technical grade emulsion stabilizer GM-14 in four liters of deionized water (aqueous phase). The solution of 260 ml divinylbenzene, 140 ml ethylvinylbenzene, 250 ml toluene, 250 ml n-octane and 2.94 g benzoyl peroxide (organic phase) is then added to the aqueous phase on stirring at room temperature. In 20 min, the temperature is raised to 80° C. The reaction is carried out at 80° C. for 8 hours and 90-92° C. for additional 2 hours. After accomplishing the copolymerization the stabilizer is rigorously washed out with hot water (60 to 80° C.) and the above organic solvents are removed by steam distillation. The beads obtained are filtered, washed with 1 l dioxane and with deionized water. Finally, the beads are dried in oven at 60° C. overnight.

The polymer obtained in Example 1

displayed apparent inner surface area of 1200 sq.m/g and total pore volume of 0.8 ml/g,

increased its volume in ethanol by a factor of 1.3,

adsorbed Cytochrome C from a phosphate buffer solution in an amount of 32-34 mg per 1 g of the polymer,

efficiently removed beta2-microglobuline from blood of patients on permanent dialysis treatment,

did pass successfully the hemocompatibility test (recalcification of plasma within the allowed 126-144 sec time limits) without any chemical modification or additional treatment of the surface of polymeric beads.

Individual spherical beads of the polymer of 0.4-0.63 mm in diameter were mechanically destroyed at a loading of 450±50 g, which is much better as compared to typical macroporous beads (about 120-150 g), but not as good as typical hypercrosslinked beads (up to 600 g) of a comparable diameter and total porous volume.

### EXAMPLE 2

As in Example 1, taking 220 ml divinylbenzene, 180 ml ethylvinylbenzene, 150 ml toluene, 150 ml n-octane and 3.0 g benzoyl peroxide as the organic phase. Inner surface area of the product obtained amounts to 1000 sq.m/g. Volume swelling with ethanol amounts to 1.25.

### EXAMPLE 3

As in Example 1, taking organic phase consisting of 320 ml divinylbenzene, 80 ml ethylvynylbenzene, 600 ml toluene, 600 ml n-octane and 2.94 g bis-azoisobuthyric nitrile. Inner surface area of the product obtained amounts to 1150 sq.m/g. Volume swelling with ethanol amounts to 1.5.

### EXAMPLE 4

As in Example 1, taking 250 ml benzene and 250 ml methanol, instead of toluene and n-octane, as the porogen for the preparation of organic phase. Inner surface area of the product obtained amounts to 800 sq.m/g. Volume swelling with ethanol amounts to 1.3.

### EXAMPLE 5

As in Example 1, taking 200 ml ethylene dichloride and 120 ml n-hexane as the porogen. Inner surface area of the product obtained amounts to 1000 sq.m/g. Volume swelling with ethanol amounts to 1.3.

### EXAMPLE 6

As in Example 1, taking the w e of 400 ml cyclohexane and 100 ml methanol as the porogen. Inner surface area of the product obtained amounts to 800 sq.m/g. Volume swelling with ethanol amounts to 1.2.

In accordance with the present invention, the post-cross-linking which was considered as absolutely necessary in the prior art is fully eliminated by increasing of the content of divinylbenzene over the threshold of 40%. This immediately provides the polymeric network with sufficient rigidity that prevents the collapse of the porous structure. The present invention eliminates the previous essential and extremely unpleasant steps of chloromethylation and post-cross-linking of the initially prepared polymer.

While in the patent to Stringfield described in the present application there is a presence of alkylene bridges, there are no alkylene bridges in the material produced in accordance with the present invention. This difference has been revealed by physical-chemical techniques including IR and NMR spectroscopy. This difference results in the difference of chemical properties of the materials (i.e., the degree of substitution of aromatic rings, resistance to oxidation agents, density of surface exposed vinyl groups, easiness of introducing functional groups into the latter or onto the surface of polymer beads, etc.), as well as difference in physical properties (i.e., surface tension and wetting properties, thermal stability, etc.).

The material obtained in accordance with the example 1 and identified as DVB-8 has the following distribution of pores:

| | | |
|---|---|---|
| BET Surface Area: | 571 | m²/g |
| T-plot Surface Area: | 410 | m²/g |
| Maximum N2 Adsorption: | 0.03580 | moles/g |
| Maximum Pore Volume: | 1.2 | cc/g |
| Volume Pores >20 A: | 1.17 | cc/g |
| Micropore Volume | 0.06 | cc/g |

Pore Size Distribution Calculated by ASTM Method D4641 -88

Pore Diameter Range A Pore Volume, cc/g

Pore Size Distribution Calculated by ASTM Method D4641-88

| Pore Diameter Range A | Pore Volume, cc/g |
|---|---|
| macro >5000 | 0.007 |
| 2000-5000 | 0.003 |
| 1500-2000 | 0.001 |
| 1000-1500 | 0.002 |
| 900-1000 | 0.000 |
| 800-900 | 0.001 |
| 700-800 | 0.001 |
| 600-700 | 0.001 |
| 550-600 | 0.001 |
| 500-550 | 0.002 |
| 450-500 | 0.001 |
| 400-450 | 0.002 |
| 350-400 | 0.003 |
| 300-350 | 0.005 |
| 250-300 | 0.064 |
| 200-250 | 0.354 |
| 150-200 | 0.275 |
| 100-150 | 0.175 |
| 80-100 | 0.062 |
| 60-80 | 0.059 |
| 40-60 | 0.060 |
| 20-40 | 0.090 |
| Total Pores >20 A | 1.169 |
| >5000 | 0.007 |
| 2000-5000 | 0.003 |
| 1000-2000 | 0.003 |
| 800-1000 | 0.003 |
| 300-600 | 0.013 |
| 100-300 | 0.868 |
| 20-100 | 0.272 |

It can be concluded from the table that the polymer in accordance with the present invention has at least 50% of the total pore volume in the range between 2 and 20 n/m, i.e., in the range of mesoporosity, as follows:

| | | | |
|---|---|---|---|
| Micro | <2 | nm | 0.071 cc/g |
| Mesa | 2.0-20 | nm | 0.721 cc/g |
| Transition from meso to macro | 20-30 | nm | 0.354 cc/g |
| Macro | >30 | nm | 0.029 cc/g |
| Total | | | 1.240 cc/g |

It will be understood that each of the elements described above, or two or more together, may also find a useful application in other types of materials and methods differing from the types described above.

While the invention has been illustrated and described as embodied in a hypercrosslinked polymeric material for purification of physiological liquids of organism, and a method of producing the material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A porous polymeric adsorbing material with adsorption capacity with respect to solutes in a molecular weight range of 5,000 to 50,000 Dalton, with an enhanced portion of mesopores, in addition to micropores and macropores, and which is prepared by a method consisting of the step of polymerization of an aromatic divinyl compound or copolymerization of an aromatic monovinyl compound with more than 40 mol % of an aromatic divinyl compound, so that the aromatic divinyl compound with the quantity of more than 40 mol % forms cross-linking bridges in such numbers which make a porous polymer network stable without additional subsequent bridging, in the presence of porogens or mixtures of porogens with properties close to those of θ-solvents.

2. A material as defined in claim 1, wherein said aromatic divinyl compound is p- or m-divinylbenzene or mixtures thereof, p- or m-diisopropenylbenzene or mixtures thereof.

3. A material as defined in claim 1, wherein said aromatic monovinyl compounds are compounds selected from the group consisting of styrene, methylstyrene, ethylvinylbenzene and vinylbenzylchloride.

4. A material as defined in claim 1, wherein said porogens are porogens selected from the group consisting of cyclohexane, cyclohexanone and other θ-solvents for polystyrene.

5. A material as defined in claim 1, wherein said porogens are θ-solvents composed of mixtures of a good solvent for polystyrene and a non-solvent for polystyrene.

6. A material as defined in claim 5, wherein said solvents for polystyrene are selected from a group consisting of toluene, benzene, xylene, diethylbenzene, ethylene dichioride, propylene dichloride, tetrachloroethyene, dioxane and methylene dichloride.

7. A material as defined in claim 5, wherein said non-solvents for polystyrene are selected from a group consisting of aliphatic hydrocarbons, aliphatic alcohols and aliphatic acids.

8. A material as defined in claim 1, wherein said porogens or mixtures of porogens with properties close to those of θ-solvents are used in amounts of 50 to 300% with respect to the volume of the comonomers.

9. A method of producing a porous polymeric adsorbing material with adsorption capacity with respect to solutes in a molecular weight range of 5,000 to 50,000 Dalton, with an enhanced portion of mesopores, in addition to micropores and macropores consisting of the step of performing polymerization of an aromatic divinyl compound, or copolymerization of an aromatic monovinyl compound with more than 40 mol % of an aromatic divinyl compound; so that the aromatic divinyl compound with the quantity of more than 40 mol % forms cross-linking bridges in such numbers which make a porous polymer network stable without additional subsequent bridging; and performing said polymerization or copolymerization in the presence of porogens or mixtures of porogens with properties close to those of θ-solvents.

10. A method as defined in claim 9, wherein said aromatic divinyl compound is p- or m-divinylbenzene or mixtures thereof, p- or m-diisopropenylbenzene or mixtures thereof.

11. A method as defined in claim 9, wherein said aromatic monovinyl compounds are compounds selected from the group consisting of styrene, methylstyrene, ethylvinylbenzene and vinylbenzylchloride.

12. A method as defined in claim 9, wherein said porogens are porogens selected from the group consisting of cyclohexane, cyclohexanone and other θ-solvents for polystyrene.

13. A method as defined in claim 9, wherein said porogens are θ-solvents composed of mixtures of a good solvent for polystyrene and a non-solvent for polystyrene.

14. A method as defined in claim 13, wherein said solvents for polystyrene are selected from a group consisting of toluene, benzene, xylene, diethylbenzene, ethylene dichloride, propylene dichloride, tetrachloroethylene, dioxane and methylene dichloride.

15. A method as defined in claim 13, wherein said non-solvents for polystyrene are selected from a group consisting of aliphatic hydrocarbons, aliphatic alcohols and aliphatic acids.

16. A method as defined in claim 9, wherein said porogens or mixtures or porogens with properties close to those of θ-solvents are used in amounts of 50 to 300% with respect to the volume of the comonomers.
